(19) United States
(12) Patent Application Publication
(10) Pub. No.: US 2005/0288935 A1
(43) Pub. Date: Dec. 29, 2005

(54) INTEGRATED DIALOGUE SYSTEM AND METHOD THEREOF

(76) Inventors: Yun-Wen Lee, Taipei City (TW); Jia-Lin Shen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,524

(22) Filed: Jun. 28, 2005

(30) Foreign Application Priority Data
Jun. 28, 2004 (TW) 93118735

(51) Int. Cl. G10L 21/00

(52) U.S. Cl. 704/270

(57) ABSTRACT

An integrated dialogue system is provided. The system comprises a bridge and a plurality of domains, wherein all domains are coupled to the bridge with bidirectional communications. A domain database is optional to the domains. After receiving an input data, the domain recognizes the input data and determines whether to process the input data by itself, or to process the input data in the domain and transmit a dialogue result and the input data to another domain, or transmit the input data to another domain without processing.

### CROSS-REFERENCE TO RELATED APPLICATION

This application claims the priority benefit of Taiwan application serial no. 93118735, filed on Jun. 28, 2004. All disclosure of the Taiwan application is incorporated herein by reference.

### BACKGROUND OF THE INVENTION

1. Field of the Invention

The present invention relates to a dialogue system and method, and more particularly to an integrated dialogue system and method using a bridge, or a bridge and a hyper-domain for domain integration.

2. Description of Related Art

As the demand in business services increases over the years, automatic dialogue systems such as portal sites, business telephone systems or business information search systems have been widely applied for providing information search or business transaction services to clients. Following are automatic dialogue systems descriptions of prior art.

FIG. 1 is a schematic block diagram showing a prior art dialogue system. Referring to FIG. 1, the prior art dialogue system 100 comprises a main menu and a plurality sets of data 104a, 104b and 104c. All of the data 104a, 104b and 104c are combined to form an all-in-one dialogue system. Each set of data cannot operate separately or become an independent subsystem due to the combination of the sets of data in the same system. When one set of data fails, the dialogue system cannot operate normally even if some operations do not need the failed data. Moreover, the dialogue system is not accessible until all data are ready. Due to the disadvantage, the time-to-market for the business services is adversely affected. Because of the combination of the sets of data, the dialogue system cannot allocate more resources to more frequently-used data. Therefore, the dialogue system is relatively inefficient.

In order to resolve the issue described above, other independent dialogue systems were introduced. FIG. 2 is a schematic block diagram showing another prior art dialogue system. Referring to FIG. 2, sets of data 204a, 204b, 204c to 204n have been developed independently and the users may select and combine, for example, sets of data 204a, 204b and 204c a dialogue system 200 according to their requirements. Users may look for the desired services by button strikes or voice input. The system 200 finds information required by users. Due to the parallel developments of data 204a, 204b and 204c, the development time for the dialogue system 200 is reduced, and the sets of data 204a, 204b and 204c can be separately accessed.

However, users nowadays require the integration of multiple-tier data. For example, when a user plans and prepares for a trip, the user might want to access information about, such as airline booking, hotel reservation, and the weather information at the destination. None of these prior art dialogue systems described above provides services for integration of information. In prior art dialogue systems, user had to repeat operation commands to obtain desired information. This repetition of commands is time-wasting and troublesome. Therefore, an integration dialogue system that can avoid drawbacks of repeating input commands is highly desired.

### SUMMARY OF THE INVENTION

Accordingly, the present invention is directed to an integration dialogue system, which automatically recognizes the requirements of users and provides automatic dialogues and services.

The present invention is also directed to an integrated dialogue method for automatically recognizing the requirements of users and providing automatic dialogues and services.

The present invention discloses an integrated dialogue system. The system comprises a plurality of domains and a bridge. The bridge is coupled to each of the domains with bilateral communication respectively. After one of the domains, for example, a first domain, receives and recognizes input data, the first domain determines whether to process the input data by itself or to transmit the input data to a second domain via the bridge.

In an embodiment of the present invention, at least one of the domains comprises a domain database.

In an embodiment of the present invention, after recognizing the input data, the first domain further determines whether to process the input data by itself, or to generate a dialogue result by processing the input data in the first domain and transmit the dialogue result to the second domain, or to transmit the input data to the second domain without processing the input data.

In an embodiment of the present invention, the first domain obtains a local domain dialogue command and/or a dialogue parameter information, and generates a dialogue history information by recognizing the input data. If the first domain merely obtains the local domain dialogue command after recognizing the input data, the first domain will generate a dialogue result according to the local domain dialogue command and/or the dialogue history information. If the first domain obtains the dialogue parameter information and keywords in other domains after recognizing the input data, the first domain will transmit the input data and/or the dialogue parameter information and/or the dialogue history information to the second domain via the bridge. If the first domain obtains the local domain dialogue command, dialogue history information, and keywords in other domains after recognizing the input data, the first domain will transmit the input data to the second domain via the bridge according to a dialogue result received by the local domain dialogue command and/or the dialogue parameter information and/or the dialogue history information. If the first domain cannot obtain the local domain dialogue command and other-domain dialogue command, the first domain will send out an error signal.

In an embodiment of the present invention, the input data comprises a text input data or a voice input data.

In an embodiment of the present invention, each of the domains comprises a recognizer and a dialogue controller. The recognizer comprises a voice input to receive the voice input data, and/or a text input to receive the text input data, wherein the recognizer recognizes the voice input data or the text input data, and the recognizer is coupled to the bridge with bidirectional communications. The dialogue controller is coupled to the recognizer, wherein when the voice input data or the text input data is determined to be processed in the first domain, the dialogue controller receives information from the recognizer and processes the voice input data and/or the text input data to generate a dialogue result.

In an embodiment of the present invention, each of the domains further comprises a text-to-speech synthesizer, a voice output and a text output. The text-to-speech synthesizer is coupled to the dialogue controller for receiving and transforming the dialogue result into a voice dialogue result. The voice output is coupled to the text-to-speech synthesizer for sending out the voice dialogue result. The text output is coupled to an output for sending out the text dialogue result.

In an embodiment of the present invention, the recognizer comprises a voice recognition module, a grammar recognition module and a domain selector. The voice recognition module is coupled to the voice input for receiving the voice input data. The voice recognition module comprises a local domain lexicon corresponding to the domain with the recognizer, to determine a lexicon relationship between the voice input data and the domain with the recognizer and to output a recognized voice data. The grammar recognition module is coupled to the text input for receiving the text input data and to the voice recognition module for receiving the recognized voice data. The grammar recognition module comprises a local domain grammar database corresponding to the domain with the recognizer, to determine a grammar relationship between the text input data/recognized voice data and the domain with the grammar and to output a recognized data. The domain selector is coupled to the grammar recognition module, the dialogue controller and the bridge for generating a domain related to the recognized data according to the recognized data, the lexicon relationship and the grammar relationship.

In an embodiment of the present invention, the voice recognition module further comprises an explicit domain transfer lexicon database and an explicit domain transfer grammar database. The explicit domain transfer lexicon database serves to determine whether the voice input data is correlated to a first portion of data in the explicit domain transfer lexicon database. If yes, the voice input data is determined to be related to the domain corresponding to the first portion of data. The explicit domain transfer grammar database serves to determine whether the text input data or the recognized voice data is correlated to a second portion of data in the explicit domain transfer grammar database. If yes, the text input data or the recognized voice data is determined to be related to the domain corresponding to the second portion of data.

In an embodiment of the present invention, the voice recognition module further comprises at least one other-domain lexicon and at least one other-domain grammar database. The other-domain lexicon serves to determine a lexicon correlation between the voice input data and other domains. The other-domain grammar database serves to determine a grammar correlation between the text input data or the recognized voice data and other domains.

The present invention also discloses an integrated dialogue method for a bridge and a plurality of domains, wherein the bridge is coupled to each of the domains with bidirectional communications respectively. When a domain in the domains receives and recognizes an input data, this domain determines whether to process the input data or to transmit the input data to a second domain in the domains via the bridge.

In an embodiment of the present invention, after recognizing the input data, the method further determines whether to process the input data in the first domain, or to generate a dialogue result by processing the input data in the first domain and transmit the dialogue result to the second domain, or to transmit the input data to the second domain without processing the input data in the first domain.

In an embodiment of the present invention, the method further receives a local domain dialogue command and/or a dialogue parameter information, and generates dialogue history information by recognizing the input data. If only the local domain dialogue command is obtained after the input data is recognized, the first domain will generate a dialogue result according to the local domain dialogue command and/or the dialogue history information. If only the dialogue parameter information is obtained after the input data is recognized, the first domain will transmit the input data and/or the dialogue parameter information and/or the dialogue history information to the second domain via the bridge. If the local domain dialogue command and the dialogue history information are obtained together after the input data is recognized, the first domain transmits the input data to the second domain via the bridge according to a dialogue result received by the local domain dialogue command and/or the dialogue parameter information and/or the dialogue history information. If the first domain does not receive a dialogue command for the local domain and all other domains, the first domain will response an error signal.

The present invention further discloses an integrated dialogue system. The system comprises a hyper-domain, a plurality of domains and a bridge. The hyper-domain receives and recognizes an input data. The bridge is coupled to each of the domains with bidirectional communications respectively. After the hyper-domain recognizes the input data and determines that the input data is related to a first domain in the domains, the input data is transmitted to the first domain via the bridge. After the first domain processed the input data and generated a dialogue result, the dialogue result is transmitted back to the hyper-domain via the bridge.

In an embodiment of the present invention, after the dialogue result is received, the hyper-domain recognizes the input data and the dialogue result to be related to the second domain, and therefore transmits the input data and the dialogue result to the second domain via the bridge.

In an embodiment of the present invention, after receiving the dialogue result, the hyper-domain will output the dialogue result. The output is in a voice and/or a text form.

In an embodiment of the present invention, the hyper-domain comprises a hyper-domain database. Or at least one of the domains comprises a domain database.

In an embodiment of the present invention, the input data comprises a text input data or a voice input data.

In an embodiment of the present invention, the hyper-domain comprises a recognizer and a dialogue controller. The recognizer is coupled to the bridge with the bidirectional communication. The recognizer has a voice input to receive the voice input data, and/or a text input to receive the text input data. The recognizer recognizes whether the voice input data or the text input data relates to the first domain and transmits the input data to the first domain via the bridge and receives the dialogue result back from the first domain. The dialogue controller is coupled to the recognizer to receive and process the dialogue result.

In an embodiment of the present invention, the hyper-domain further comprises a text-to-speech synthesizer, a voice output and a text output. The text-to-speech synthesizer is coupled to the dialogue controller for receiving and transforming the text dialogue result into a voice dialogue result. The voice output is coupled to the text-to-speech synthesizer for sending out the voice dialogue result. The text output is coupled to an output for sending out the dialogue result.

In an embodiment of the present invention, the recognizer comprises a voice recognition module, a grammar recognition module and a domain selector. The voice recognition module is coupled to the voice input for receiving the voice input data and sending out a recognized voice data and a lexicon relationship. The grammar recognition module, coupled to the text input for receiving text input data and to the voice recognition module for receiving recognized voice data, generates recognized data and a grammar relationship. The domain selector is coupled to the grammar recognition module, the dialogue controller and the bridge for recognizing a domain related to the recognized data.

In an embodiment of the present invention, the voice recognition module further comprises an explicit domain transfer lexicon database and a plurality of other-domain lexicons. The explicit domain transfer lexicon database recognizes whether the voice input is correlated to a first portion of data in its database. If the recognition result is yes, this voice input data is determined to be related to the domain corresponding to the first portion of data. Each of the other-domain lexicons corresponds to each of the domains for recognizing the voice input data and gets a lexicon-relationship of each domain.

In an embodiment of the present invention, the grammar recognition module further comprises an explicit domain transfer grammar database and a plurality of other-domain grammar databases. When the text input data or the recognized voice data is correlated to a second portion of explicit domain transfer grammar database, the text input data or the recognized voice data is determined to be related to the domain corresponding to the second portion of data. Each of the other-domain grammar databases correspond to each of the domains for recognizing the text input data or the recognized voice data and grammar-relationship of the domains.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is a schematic block diagram showing a prior art dialogue system.

FIG. 2 is a schematic block diagram showing another prior art dialogue system.

FIG. 3 is a schematic block diagram showing an integrated dialogue system according to an embodiment of the present invention.

FIG. 4 is a schematic block diagram showing a domain of an integrated dialogue system according to an embodiment of the present invention.

FIG. 5 is a schematic block diagram showing a recognizer of an integrated dialogue system according to an embodiment of the present invention.

FIG. 6 is a schematic block diagram showing an integrated dialogue system according to another embodiment of the present invention.

FIG. 7 is a schematic block diagram showing a hyper-domain of an integrated dialogue system according to an embodiment of the present invention.

FIG. 8 is a schematic block diagram showing a recognizer of an integrated dialogue system according to an embodiment of the present invention.

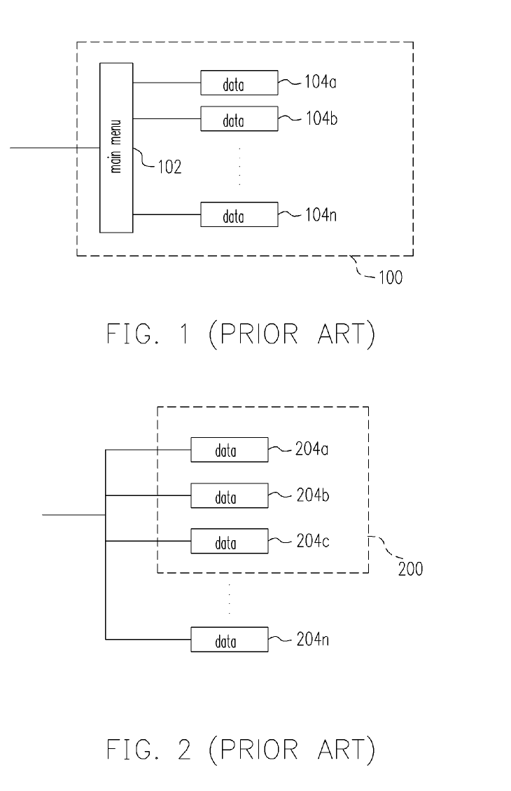

### DESCRIPTION OF EMBODIMENTS

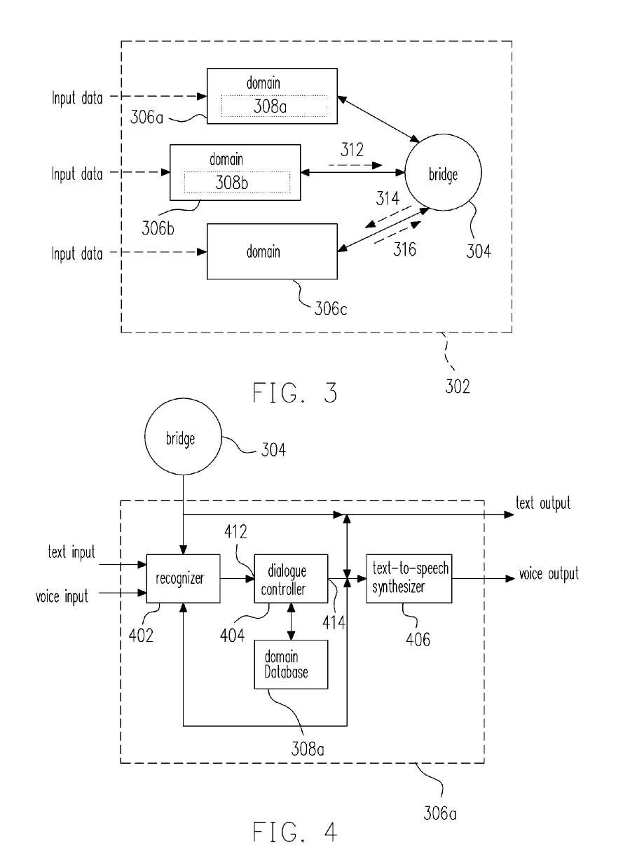

FIG. 3 is a schematic block diagram showing an integrated dialogue system according to an embodiment of the present invention. Referring to FIG. 3, the integrated dialogue system 302 comprises a bridge 304 and domains 306a, 306b and 306c, wherein the domains 306a, 306b and 306c may optionally comprise a domain database. For example, as shown in FIG. 3, the domains 306a and 306b comprise the domain databases 308a and 308b, respectively, and the domain 306c does not comprise a domain database. In this embodiment, the integrated dialogue system 302 comprises three domains. The present invention, however, is not limited thereto. The integrated dialogue system 302 may comprise any number of domains. The bridge 304 is coupled to the domains 306a, 306b and 306c with bilateral communications respectively for bilaterally transmitting data between the domains 306a, 306b and 306c and the bridge 304. A user may start a dialogue or input data to any one of the domains 306a, 306b and 306c.

When any one of the domains 306a, 306b and 306c receives the input data, the domain recognizes the input data so as to determine whether to process the input data locally, or to process the input data to generate a dialogue result and transmit the dialogue result to a next domain, or to transmit the input data to a next domain without processing the input data.

For example, when the domain 306b in FIG. 3 receives the input data such as “I want to book an airline ticket to New York City on July 4 and a hotel room”. It is assumed the domain 306b is corresponding to the airline booking, thus the domain 306b recognizes a local domain dialogue command “Book an airline ticket to New York City on July 4”. It is noted that, the hotel information of the input data is not related to the domain 306b. The domain 306b recognizes a voice feature from the input data, and recognizes other-domain keywords, such as “hotel”, from the voice feature and other-domain keywords defined in explicit domain transfer lexicon database for a second domain, such as the domain 306c. The voice feature, the other-domain keywords and the second domain constitute dialogue parameter information. In some embodiments of the present invention, contents of the dialogue parameter information depend on the voice feature, the network bandwidth and the operating efficiency. The method to recognize the second domain will be explained in detail below. The domain database 308b in the domain 306b operates a dialogue so as to generate the dialogue result “Book an airline ticket to the airport near to New York City on July 4”. In addition, the domain 306b may output the dialogue result to the user and inform the user that the dialogue is to be processed in the second domain.

As shown by operation 312 in FIG. 3, the domain 306b sends out the input data, the dialogue result, the dialogue parameter information and the dialogue history information to the bridge 304. Via operation 314, the bridge 304 transmits the input data, the dialogue result, the dialogue parameter information and the dialogue history information to the second domain, i.e. domain 306c. Another dialogue command “book a room of a hotel in New York City on July 4” and another dialogue may be initiated and operated in the domain 306c. The domain 306c transmits the dialogue result related to the hotel information to the domain 306b via the bridge 304. Then the dialogue result related to the hotel information is output to the user. Alternatively, a combination of the hotel information and the airline booking dialogue result is sent out to the user.

In this embodiment described above, the user can input another data, such as weather information after receiving the airline booking dialogue result. Or the user may input another data after receiving the hotel information dialogue result. The domain, which receives a further input information, combines the dialogue parameter information and the dialogue history information to generate a new dialogue command, for example, “Inquiry the weather information in New York City on July 4”. The dialogue parameter information and the dialogue history information are useful in determining if the following input data is related to the prior dialogue result, to determine which domain to process the following input data.

Assumed that the input data, “I want to book an airline ticket to New York City on July 4”, is entered into the airline booking domain. If only the local domain dialogue command “Book an airline ticket to New York City on July 4” is recognized and obtained, the domain will execute a dialogue to generate a dialogue result according to the local domain dialogue command.

Assumed that the input data, “I want to book an airline ticket to New York City on July 4”, is entered into the hotel domain. Then, after recognition, if only a dialogue parameter information, comprising the voice feature, the other-domain keyword “airline ticket”, and other-domain keyword, is recognized and obtained, the hotel domain transmits the input data and/or the dialogue parameter information and the dialogue history information to the second domain via the bridge 304.

In some embodiments of the present invention, if the input data “I want to book an airline ticket to New York City on July 4 and a hotel room over there” is entered into the domain related to the airline booking, thus the local domain dialogue command “Book an airline ticket to New York City on July 4” and the dialogue parameter information (e.g., related to hotel room) will be queried in one dialogue turn. Then, the domain will transmit the input data, the dialogue result from processing the local domain dialogue command, the dialogue parameter information and the dialogue history information to the second domain via the bridge 304. Once second domain completed this request, it will reply the dialogue results back via the bridge 304, and dialogue controller will combine all dialogue results, and report to user in one dialogue turn. If one domain sends data to other domain via the bridge, the sending domain will wait a timeout to get processed response from the specified domain. If the sending domain successfully got response from other domain before timeout, it will use received dialogue response to response user. Otherwise, the sending domain will report error message to user to notify needed domain is out of sync. Even that domain response after timeout, the sending domain will ignore it, but notify user that domain is alive again.

According to an embodiment of the present invention, if no local domain dialogue command and other-domain dialogue command is recognized and obtained, an error signal will be sent to the user.

According to an embodiment of the present invention, the user may enter the input data to the integrated dialogue system 302, for example, in a voice form or in a text form.

FIG. 4 is a schematic block diagram showing a domain of an integrated dialogue system according to an embodiment of the present invention. Referring to FIG. 4, each of the domains 306a, 306b and 306c of the integrated dialogue system 302 comprises a recognizer 402, a dialogue controller 404 and a text-to-speech synthesizer 406. As shown in FIG. 3, the domains 306a and 306b comprise domain databases 308a and 308b respectively, and the domain 306c does not have a domain database. The recognizer 402 comprises a voice input and/or a text input. The voice input serves to receive the voice input data (e.g., “I want to book an airline ticket to New York City on July 4 and a hotel room”) in a voice form. The text input serves to receive the text input data (e.g., “I want to book an airline booking to New York City on July 4 and a hotel room”) in text form. Note that at lease one input method is required. The recognizer 402 recognizes the voice input data or text input data and obtains the local domain dialogue command and/or dialogue parameter information comprising the voice feature, other-domain keywords, and other domains related to other-domain keywords; and the dialogue history information. If the recognizer 402 only recognizes the local domain dialogue command, the local domain dialogue command and/or the dialogue history information are transmitted to the dialogue controller 404. The dialogue controller 404 may process the local domain dialogue command and/or the dialogue history information by itself if no domain database exists in the domain including the dialogue controller 404. Or the dialogue controller 404 may generate the dialogue results incorporated with the domain database 308a, and then the dialogue results are transmitted to the recognizer 402. If the recognizer 402 only obtains the dialogue parameter information, then the text or voice input data and/or the dialogue parameter information and/or the dialogue history information are transmitted to the second domain via the bridge 304. If the recognizer 402 obtains the dialogue parameter information and the dialogue parameter information together, the dialogue result and/or the text or voice input data and/or the dialogue parameter information and/or the dialogue history information are transmitted to the second domain via the bridge 304.

According to an embodiment of the present invention, each domain comprises a voice output, coupled to the control output 414 of the dialogue controller 410 via the text-to-speech synthesizer 406. The text-to-speech synthesizer 406 receives and transforms the dialogue results into a speech dialogue which is sent to the user in voice form via the voice output.

According to an embodiment of the present invention, the domain comprises a text output, coupled to the control output 414 of the dialogue controller 410. The text output sends out the dialogue results to the user in text.

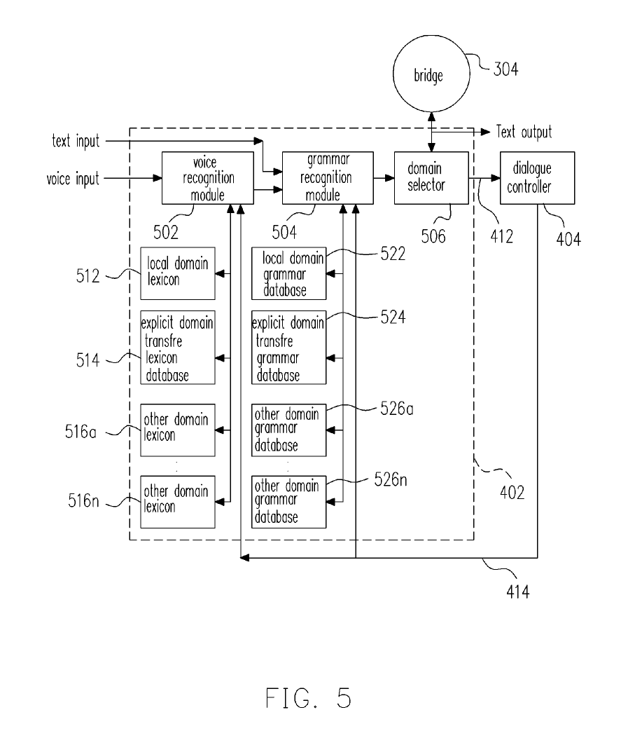

FIG. 5 is a schematic block diagram showing a recognizer of an integrated dialogue system according to an embodiment of the present invention. Referring to FIG. 5, the recognizer 402 comprises a voice recognition module 502, a grammar recognition module 504 and a domain selector 506.

According to an embodiment of the present invention, the voice recognition module 502 comprises a domain lexicon 512 related to the domain of the recognizer 402. The grammar recognition module 504 comprises a local domain grammar database 522 related to the domain of the recognizer 402. According to an embodiment of the present invention, the voice recognition module 502 comprises an explicit domain transfer lexicon database 514 and/or a plurality of other-domain lexicons 516a-516n. The grammar recognition module 504 comprises an explicit domain transfer grammar database 524 and/or a plurality of other-domain grammar databases 526a-526n. The explicit domain transfer lexicon database 514 comprises keywords for other domains, such as the weather domain comprising temperature or rain keywords.

Referring to FIG. 5, the voice recognition module 502 is coupled to the dialogue controller 404 for receiving the dialogue results, and coupled to the voice input for receiving and transforming the voice input data into an recognized voice data. According to an embodiment of the present invention, it is assumed that the domain 306b, which is related to the airline booking, receives the voice input data “I want to book an airline ticket to New York City on July 4 and a hotel room”. The information regarding “I want to book an airline ticket to New York City on July 4” can be recognized by the domain lexicon 512 of the domain 306b, and a tag [306b] is added thereto. The information regarding “hotel room” cannot be recognized by the domain lexicon 512. If the domain 306b comprises the explicit domain transfer lexicon database 514 and/or the other-domain lexicons 516a-516n including the keyword “hotel” and its domain 306c, the voice input data is recognized as an recognized voice data with a multiple-domain lexicon tag “I want to book an airline ticket to New York City on July 4 [306b] and a hotel room [306c]”. According to an embodiment of the present invention, lexicon weights are generated corresponding to the domain lexicon tags based on the domain lexicon 512, the domain lexicon database 514, the other-domain lexicons 516a-516n and the dialogue result. The lexicon weights represent the relationships between the domain lexicon tags and the related domains. For example, in the input data described above, the first input data finally comprises “I want to book an airline ticket to New York City on July 4 [306b, 90%] and a hotel room [306c, 90%]”.

Referring to FIG. 5, the grammar recognition module 504 is coupled to the dialogue controller 404 for receiving the dialogue result, coupled to the text input for receiving the text input data and coupled to the voice recognition module 502 for receiving the recognized voice data. The grammar recognition module 504 transforms the text input data or the recognized voice data into a recognized text data. For example, the domain 306b, related to airline booking, receives and transforms the voice input data “I want to book an airline ticket to New York City on July 4 and a hotel room” into the recognized voice data “I want to book an airline ticket to New York City on July 4 [306b, 90%] and a hotel room [306c, 90%]”. The local domain grammar database 522 of the domain 306b analyzes the grammar of the recognized voice data related to the domain, such as “I want to book an airline ticket to New York City on July 4 [306b, 90%]”. If the domain 306b comprises the explicit domain transfer grammar database 524 and/or the other-domain grammar databases 526a-526n, the domain 306b generates another dialogue result, such as “Book a hotel room [306c, 90%]”, which is not related to the local domain grammar database 522. Accordingly, the domain recognition module 504 transforms the recognized voice data into the recognized data “I want to book an airline ticket to New York City on July 4 [306b, 90%] {306b} and a hotel room [306c, 90%] {306c}” with multiple-domain grammar tags. According to an embodiment of the present invention, grammar weights are generated corresponding to the domain grammar tags based on the local domain grammar database 522, explicit domain transfer grammar database 524, and other-domain grammar databases 526a-526n. The grammar weights represent the relationships between the domain grammar tag and the related domains. The first input data is finally processed as “I want to book an airline ticket to New York City on July 4 [306b, 90%] {306b, 80%} and a hotel room [306c, 90%] {306c, 80%}.

The domain selector 506 is coupled to the grammar recognition module 504 for receiving recognized data. The domain selector 506 obtains the local domain dialogue command or the dialogue parameter information, such as the voice feature, the other-domain keyword, or the domain related to the other-domain keyword, and the dialogue history data based on the domain lexicon tags, the lexicon-relationship, the domain grammar tags and the grammar-relationship. Accordingly, if the domain 306b executes recognition, the local domain dialogue command “I want to book an airline ticket to New York City on July 4”; the other-domain keyword “hotel”; and the second domain 306c are recognized. The domain selector 506 is coupled to the dialogue controller 404 for sending out the local domain dialogue command to the dialogue controller 404. The domain selector 506 is coupled to the bridge 304 for sending out the input data, the search results, the dialogue parameter information and the dialogue history information to the bridge 304. If a domain got data from the bridge, i.e., speech waveform, feature, or text of recognized speech, and/or dialogue history, the received domain will use received data as same as domain input. e.g., recognition for input waveforms or NLU parses for input text of recognized speech. If the received data is recognized to process in received domain, it will use input data to process dialogue control and got dialogue response to get back to sender via bridge. If received domain recognized input data need to transmit to other domain, unless that domain is belong to senders that send this data, it will transmit data via the bridge to other domain to make that domain process the dialogue to get response. If such domain is belonging to senders, an error message is reported via the bridge.

The present invention also discloses an integrated dialogue method. The method is applied to an integrated dialogue system comprising a bridge and a plurality of domains. The bridge is coupled to each domain with a bilateral communication respectively. After a first domain in the domains receives and recognizes an input data, the first domain determines whether to process the input data or to transmit the input data to a second domain via the bridge.

In an embodiment of the present invention, after recognizing the input data, the method further determines whether to process the input data in the first domain, or to process the input data in the first domain to generate a dialogue result and transmit the dialogue result to the second domain, or to transmit the input data to the second domain without processing the input data in the first domain.

According to an embodiment of the present invention, the input data, and at least one of a local domain dialogue command and dialogue parameter information is recognized and obtained and a dialogue history information is generated. If only the local domain dialogue command is obtained, the first domain generates a dialogue result according to the local domain dialogue command and/or the dialogue history information. If only the dialogue parameter information is obtained, the first domain transmits the input data and/or the dialogue parameter information and/or the dialogue history information to the second domain via the bridge. If the local domain dialogue command and the dialogue history information are obtained together, the first domain transmits the input data to the second domain via the bridge according to a dialogue result received by the local domain dialogue command and/or the dialogue parameter information and/or the dialogue history information. If the first domain cannot receive the local domain dialogue command and an other-domain dialogue command, the first domain sends out an error signal.

According to an embodiment of the present invention, after generating the dialogue result by processing the input data, the dialogue result is a voice or text output to the user. The steps of the method are described with reference to FIG. 4. Detailed descriptions are not repeated.

Accordingly, in the present invention, the domains can be set up separately. The bridge is then coupled to the domains for constituting the integrated dialogue system. Each of the domains of the present invention can be separately designed without affecting designs of other domains. Moreover, any new domain, if necessary, can be added to the integrated dialogue system. The integrated dialogue system integrates different domains by using the bridge for different applications. Accordingly, different applications are built on different domains; none of the same applications are going to be built on different domains. The structure of the system is, therefore, relatively simple, and the cost effective. Moreover, when any of the domains is failed, the dialogue can start from other domains, and other domains can still execute dialogues without affecting the operation of the whole integrated dialogue system. By using the bridge, all of the domains share information with each other. In addition, the dialogue parameter information and the dialogue history information reserve the prior command input from the user without repeating the same command. The domain lexicon tags and weights, and the domain grammar tags and weights are added to the recognized voice data and the recognized data for accelerating the precise recognition of the local domain dialogue command and the dialogue parameter information by using the domain selector.

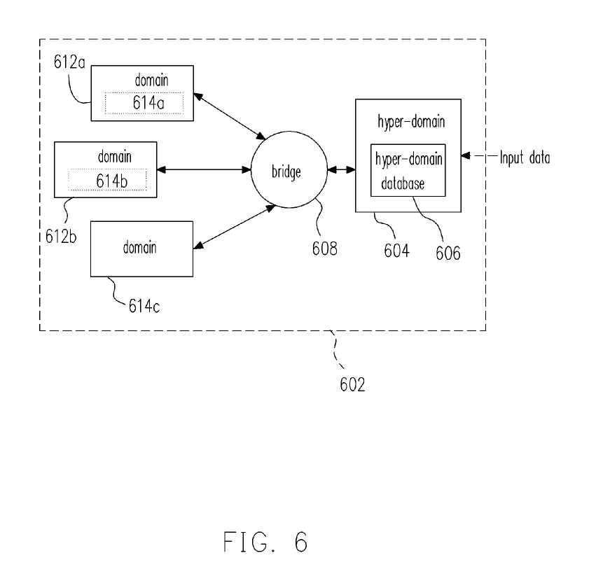

FIG. 6 is a schematic block diagram showing an integrated dialogue system according to another embodiment of the present invention. Referring to FIG. 6, the integrated dialogue system 602 comprises a hyper-domain 604, a bridge 608 and a plurality of domains 612a-612c, wherein the domains may optionally comprise a domain database. In this embodiment shown in FIG. 6, the domains 612a and 612b comprise domain databases 614a and 614b; and the domain 612c does not have a domain database. The hyper-domain 604 may optionally comprise a hyper-domain database 606. The bridge 608 is coupled to the hyper-domain 604 and the domain 612a-612c with bidirectional communications. In the present invention, the integrated dialogue system 602 may comprise arbitrary number of domains. In some embodiments of the present invention, the hyper-domain 604 recognizes the input data first and the results are transmitted to the domains via the bridge 608. It means that, after the input data is recognized, the hyper-domain 604 finds out at least one domain, which is related to the input data, and transmits the input data to the domain.

Referring to FIG. 6, it is assumed a user inputs the input data (e.g., “I want to book an airline ticket to New York City on July 4 and a hotel room”) from the hyper-domain 604 into the integrated dialogue system 602. After the hyper-domain 604 receives the input data, the hyper-domain 604 generates a first domain dialogue command “I want to book an airline ticket to New York City on July 4”, and recognizes a first domain 612b corresponding thereto. The first domain dialogue command is then transmitted to the first domain 612b via the bridge 608.

After receiving the first domain dialogue command, the first domain 612b makes a dialogue with the first domain database 614b to generate a first dialogue result, e.g., “An airline booking to New York City on July 4”, which is then transmitted to the hyper-domain 604.

After receiving the dialogue result, the hyper-domain 604 generates a second domain dialogue command and the second domain corresponding to the second domain dialogue command. For example, the dialogue result “An airline booking to New York City on July 4” and the input data “I want to book an airline ticket to New York City on July 4 and a hotel room” are processed so as to generate the second domain command “Book a hotel room at New York City on July 4”. The bridge 608 then transmits the second domain command to the second domain for dialogue.

In the integrated dialogue system, if the first domain command can not be generated by recognizing the input data, an error signal is output.

According to an embodiment of the present invention, a user enters the input data to the integrated dialogue system by entering voice input data or text input data.

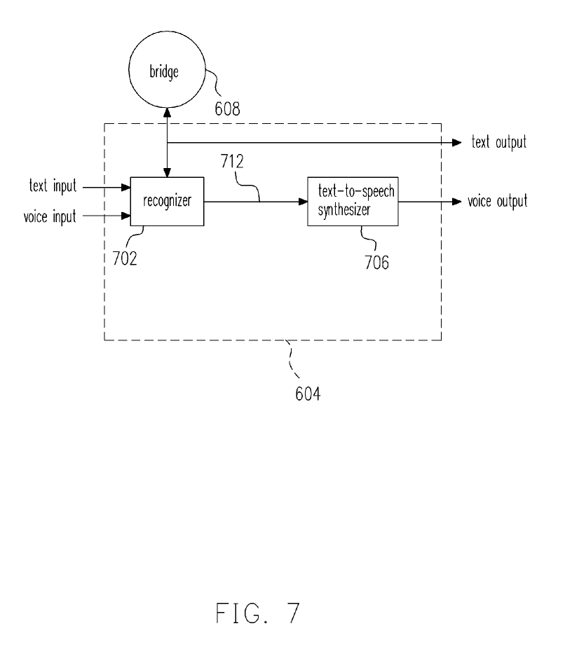

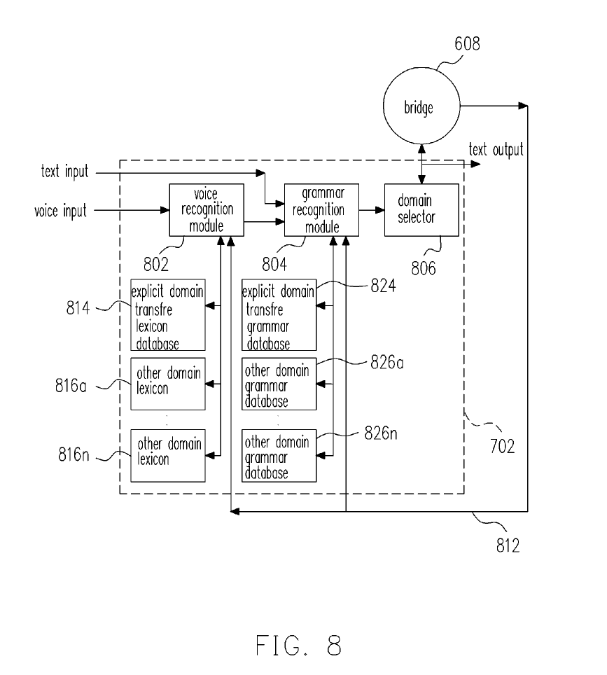

FIG. 7 is a schematic block diagram showing a hyper-domain of an integrated dialogue system according to an embodiment of the present invention. Referring to FIG. 7, the hyper-domain 604 of the integrated dialogue system 602 comprises a recognizer 702 and a text-to-speech synthesizer 706. The recognizer 702 comprises a voice input for receiving the voice input data, and/or a text input for receiving the text input data. The recognizer 702 recognizes the voice input data or the text input data to generate the first domain dialogue command and the first domain corresponding thereto. The text-to-speech synthesizer is coupled to the recognizer 702 for receiving and transforming the dialogue result into a voice dialogue result which is sent out in a voice form from the voice output to the user. The text output is coupled to the recognizer 702 for sending out the dialogue result in a text form to the user.

FIG. 8 is a schematic block diagram showing a recognizer of an integrated dialogue system according to an embodiment of the present invention. Referring to FIG. 8, the recognizer 702 comprises a voice recognition module 802, a grammar recognition module 804 and a domain selector 806.

The voice recognition module 802 comprises an explicit domain transfer lexicon database 814 and/or a plurality of other-domain lexicons 816a-816n. The grammar recognition module 804 comprises an explicit domain transfer grammar database 824 and/or a plurality of other-domain grammar databases 826a-826n. The explicit domain transfer lexicon database 814 comprises keywords for all domains.

Compared with the integrated dialogue system in FIG. 5, the dialogue history information is entered into the recognizer 702 via the bridge 808. The recognizer 702 is similar to the recognizer 402 in FIG. 4. Detailed descriptions are not repeated.

Accordingly, the present invention separately sets up the databases for the domains. A hyper-domain and a bridge are coupled to all domains so as to constitute an integrated dialogue system. Every domain can be separately designed without affecting other domains. Any new domain can be optionally added to the integrated dialogue system anytime. The integrated dialogue system integrates different domains by using the hyper-domain and the bridge for different applications. Different applications are built on different domains; none of the same applications are going to be built on the different domains. The dialogue controller collects the dialogue conditions and restricts the searching scope of the dialogue for multiple dialogues. The hyper-domain integrates information of the domains for different applications. The input data from the user can be more precisely recognized and transmitted to a proper domain.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An integrated dialogue system, comprising:
a plurality of domains, after received by a first domain, an input data recognized by the first domain; and
a bridge, coupled to each of the domains with a bidirectional communication respectively;
wherein after the input data is recognized, the first domain determines whether to process the input data or to transmit the input data to a second domain via the bridge.

2. The integrated dialogue system of claim 1, wherein at least one of the domains comprises a domain database.

3. The integrated dialogue system of claim 1, wherein the first domain processes the input data by itself.

4. The integrated dialogue system of claim 1, wherein the first domain generates and transmits a dialogue result to the second domain after process.

5. The integrated dialogue system of claim 1, wherein the first domain transmits the input data to the second domain without process.

6. The integrated dialogue system of claim 1, wherein the first domain obtains a local domain dialogue command and/or dialogue parameter information, and generates a dialogue history information by recognizing the input data.

7. The integrated dialogue system of claim 6, wherein when the first domain obtains the local domain dialogue command by recognizing the input data, the first domain generates a dialogue result according to the local domain dialogue command and/or the dialogue history information.

8. The integrated dialogue system of claim 6, wherein when the first domain obtains the dialogue parameter information by recognizing the input data, the first domain transmits the input data and/or the dialogue parameter information and/or the dialogue history information to the second domain via the bridge.

9. The integrated dialogue system of claim 6, wherein when the first domain obtains the local domain dialogue command and the dialogue history information by recognizing the input data, the first domain transmits to the second domain via the bridge the input data, a dialogue result based on the local domain dialogue command, and/or the dialogue parameter information and/or the dialogue history information.

10. The integrated dialogue system of claim 6, wherein when the first domain does not obtain the local domain dialogue command and an other-domain dialogue command, the first domain sends out an error signal.

11. The integrated dialogue system of claim 1, wherein the input data comprise a text input data or a voice input data.

12. The integrated dialogue system of claim 11, wherein each of the domains comprises:
an recognizer comprising a voice input to receive the voice input data, and/or a text input to receive the text input data, wherein the recognizer recognizes the voice input data or the text input data, and the recognizer is coupled to the bridge with the bidirectional communication; and
a dialogue controller, coupled to the recognizer, wherein when the voice input data or the text input data are processed in the first domain after recognized by the recognizer, the dialogue controller receives the voice input data and the text input data from the recognizer and processes to generate a dialogue result.

13. The integrated dialogue system of claim 12, wherein each of the domains further comprises:
a text-to-speech synthesizer, coupled to the dialogue controller for receiving and transforming the dialogue result into a voice dialogue result;
a voice output, coupled to the text-to-speech synthesizer for sending out the voice dialogue result; and
a text output, coupled to an output for sending out the dialogue result.

14. The integrated dialogue system of claim 12, wherein the recognizer comprises:
a voice recognition module, coupled to the voice input for receiving the voice input data, the voice recognition module comprises a local domain lexicon data base corresponding to the domain with the recognizer to determine a lexicon relationship between the voice input data and the domain with the recognizer and to output an recognized voice data;
a grammar recognition module, coupled to the text input for receiving the text input data, and coupled to the voice recognition module for receiving the recognized voice data, the grammar recognition module comprises a local domain grammar database corresponding to recognizer in the domain to determine a grammar relationship between the text input data/recognized voice data and the domain with the recognizer and to output an recognized data; and
a domain selector, coupled to the grammar recognition module, the dialogue controller and the bridge for choosing a domain related to the recognized data according to the recognized data, the lexicon relationship and the grammar relationship.

15. The integrated dialogue system of claim 14, wherein the voice recognition module further comprises:
an explicit domain transfer lexicon database, when the voice input data is related to a first portion of data in the explicit domain transfer lexicon database, the voice input data is determined to be related to the domain corresponding to the first portion of data; and
an explicit domain transfer grammar database, when the text input data or the recognized voice data is related to a second portion of data in the explicit domain transfer grammar database, the text input data or the recognized voice data is determined to be related to the domain corresponding to the second portion of data.

16. The integrated dialogue system of claim 14, wherein the voice recognition module further comprises:
at least one other-domain lexicon, for determining lexicon-relationship between the voice input data and other domains; and
at least one other-domain grammar database, for determining grammar-relationship between the text input data or the recognized voice data and other domains.

17. An integrated dialogue method for a bridge and a plurality of domains, wherein the bridge is coupled to each of the domains with a bidirectional communication, the integrated dialogue method comprising:
when a first domain in the domains receives and recognizes an input data, the first domain determines whether to process the input data by itself or to transmit the input data to a second domain in the domains via the bridge.

18. The integrated dialogue method of claim 17, after the input data is recognized, further comprises:
determining whether to process the input data in the first domain, or to generate a dialogue result after process and transmit the dialogue result to the second domain, or to transmit the input data to the second domain without processing.

19. The integrated dialogue method of claim 17, further comprising a step of obtaining a local domain dialogue command and/or a dialogue parameter information by recognizing the input data and generating dialogue history information.

20. The integrated dialogue method of claim 19, wherein when the local domain dialogue command is obtained by recognizing the input data, the first domain generates a dialogue result according to the local domain dialogue command and/or the dialogue history information.

21. The integrated dialogue method of claim 19, wherein when the dialogue parameter information is obtained by recognizing the input data, the first domain transmits the input data and/or the dialogue parameter information and/or the dialogue history information to the second domain via the bridge.

22. The integrated dialogue method of claim 19, wherein when the local domain dialogue command and the dialogue history information are obtained by recognizing the input data, the first domain transmits the input data, a dialogue result based on the local domain dialogue command and/or the dialogue parameter information and/or the dialogue history information to the second domain via the bridge.

23. The integrated dialogue method of claim 19, further comprising a step of outputting an error signal when the local domain dialogue command and an other-domain dialogue command are not obtained by recognizing the input data.

24. An integrated dialogue system, comprising:
a hyper-domain for receiving and recognizing an input data;
a plurality of domains; and
a bridge, coupled to the hyper-domain and each of the domains with bidirectional communications respectively, wherein after the hyper-domain recognizes the input data and determine at least one first domain corresponding to the input data, the input data is transmitted to the first domain via the bridge; and
after the first domain processes the input data and generates a dialogue result, the dialogue result is transmitted to the hyper-domain via the bridge.

25. The integrated dialogue system of claim 24, wherein after the dialogue result is received by the hyper-domain, the hyper-domain recognizes the input data and the dialogue result so as to recognize at least one corresponding second domain, and the hyper-domain transmits the input data and the dialogue result to the second domain via the bridge.

26. The integrated dialogue system of claim 24, wherein after the dialogue result is received by the hyper-domain, the hyper-domain sends out the dialogue result in a voice form or a text form.

27. The integrated dialogue system of claim 24, wherein the hyper-domain comprises a hyper-domain database.

28. The integrated dialogue system of claim 24, wherein at least one of the domains comprises a domain database.

29. The integrated dialogue system of claim 24, wherein the input data comprises a text input data or a voice input data.

30. The integrated dialogue system of claim 29, wherein the hyper-domain comprises:
an recognizer, coupled to the bridge with the bidirectional communication, comprising a voice input to receive the voice input data and/or a text input to receive the text input data, wherein the recognizer recognizes the voice input data or the text input data so as to determine the first domain, transmits the input data to the first domain via the bridge and receives the dialogue result from the first domain; and
a dialogue controller, coupled to the recognizer to receive and process the dialogue result.

31. The integrated dialogue system of claim 30, wherein the hyper-domain further comprises:
a text-to-speech synthesizer, coupled to the dialogue controller for receiving and transforming the dialogue result into a voice dialogue result;
a voice output, coupled to the text-to-speech synthesizer for sending out the voice dialogue result; and
a text output coupled, to an output for sending out the dialogue result.

32. The integrated dialogue system of claim 30, wherein the recognizer comprises:
a voice recognition module, coupled to the voice input for receiving the voice input data and sending out an recognized voice data and a lexicon relationship;
a grammar recognition module, coupled to the text input for receiving the text input data and coupled to the voice recognition module for receiving the recognized voice data, and generating an recognized data and a grammar relationship; and
a domain selector, coupled to the grammar recognition module, the dialogue controller and the bridge for selecting a domain related to the recognized data according to the recognized data, the lexicon relationship and the grammar relationship.

33. The integrated dialogue system of claim 32, wherein the voice recognition module comprises:
an explicit domain transfer lexicon database, when the voice input data is correlated to a first portion of data in the explicit domain transfer lexicon database, the voice input data is determined to be related to the domain corresponding to the first portion of data; and
a plurality of domain lexicons, wherein each of the domain lexicons corresponds to each of the domains respectively for recognizing the voice input data and lexicon-relationship of the domains.

34. The integrated dialogue system of claim 32, wherein the grammar recognition module comprises:
an explicit domain transfer grammar database, when the text input data or the recognized voice data is correlated to a second portion of data in the explicit domain transfer grammar database, the text input data or the recognized voice data is determined to be related to the domain corresponding to the second portion of data; and
a plurality of domain grammar databases, wherein each of the domain grammar databases corresponds to each of the domains respectively for recognizing the text input data or the recognized voice data and grammar-relationship of the domains.
